(19) United States
(12) Patent Application Publication
(10) Pub. No.: US 2024/0070827 A1
(43) Pub. Date: Feb. 29, 2024

(54) Correcting Images Degraded By Signal Corruption

(71) Applicant: Samsung Electronics Co., Ltd., Suwon-si (KR)

(72) Inventors: Musa Maharramov, The Woodlands, TX (US); Ye Zhao, San Jose, CA (US); Brian Patton, San Francisco, CA (US)

(21) Appl. No.: 18/235,663

(22) Filed: Aug. 18, 2023

Related U.S. Application Data
(60) Provisional application No. 63/399,392, filed on Aug. 19, 2022.

(51) Int. Cl. G06T 5/00; G06T 5/50

(52) U.S. Cl. CPC G06T 5/006; G06T 5/50; G06T 2207/20076; G06T 2207/20224

(57) ABSTRACT

In one embodiment, a method includes accessing (1) a corrupted image of a scene captured by a camera, (2) an estimated true image of the scene, (3) an estimated corruption operator f for the camera, and (4) one or more uncertainty metrics for f. The method further includes generating, by applying a corruption operation to the estimated true image and the corruption operator f, a predicted corrupted image of the scene captured by the camera and determining a difference between the predicted corrupted image and the corrupted image captured by the camera. The method further includes determining, based on the one or more uncertainty metrics for f, a likelihood distribution for the corruption operator f, and updating, based on the likelihood distribution for the corruption operator f and on the determined difference between the predicted corrupted image and the corrupted image captured by the camera, the estimated corruption operator f.

### PRIORITY CLAIM

This application claims the benefit under 35 U.S.C. § 119 of U.S. Provisional Patent Application 63/399,392 filed Aug. 19, 2022.

### TECHNICAL FIELD

This application generally relates to correcting images degraded by signal corruption. BACKGROUND

An image captured by a camera may be corrupted, or blurred, due to a number of factors that corrupt the physical signal representing the image (i.e., the electromagnetic (e.g., light) waves or photons representing the image). Factors that can cause signal corruption include obstructions between a scene corresponding to an image and the camera sensor(s). For example, obstructions can cause diffraction, and even media that is transparent to the physical signal may cause refraction or dispersion of that signal. In addition, noise may be a factor that corrupts a physical signal. Finally, imperfections in the camera system (e.g., camera sensor) may corrupt detection of the physical signal and image reconstruction.

### BRIEF DESCRIPTION OF THE DRAWINGS

FIG. 1 illustrates a Bayesian approach to correcting a corrupted image.

FIG. 2 illustrates an example method for determining an initial estimate of a corruption operator f for a camera and one or more uncertainty metrics for the corruption operator f.

FIG. 3A illustrates an example method for updating a corruption operator f in real-time in order to correct one or more corrupted unknown images taken by a camera system.

FIG. 3B illustrates an example graphical illustration of an embodiment of the example method of FIG. 3A

FIG. 4 illustrates an example of a point source for which distortion varies at different angles.

FIG. 5 illustrates an example of reflection-free transmission of electromagnetic waves through a heterogeneous layered medium with varying propagation velocity.

FIG. 6 illustrates an example of a nonstationary convolution operator.

FIG. 7 illustrates examples of estimated images using different estimation approaches.

FIG. 8 illustrates an example computing system.

### DESCRIPTION OF EXAMPLE EMBODIMENTS

An image captured by a camera may be corrupted, or degraded/blurred, due to a number of factors that corrupt (i.e., degrade) the true signal representing the image. Imperfections in a camera's sensing system can be one source of signal corruption. For example, a real sensor system may deviate from the system's theoretical specifications, for example due to imperfections in the system components and/or in the assembly of those components into a system. As another example, changes to a system may occur over time, e.g., as a result of wear or degradation of system components or relative changes in the configuration of those components (e.g., as a result of dropping a device containing the camera system).

Obstructions between a scene corresponding to an image and the camera sensor(s) can be a source of signal corruption. For example, an under-display camera (UDC) is a camera that is placed under the display structure of a device, such as a smartphone, tablet, TV, etc. Placing a camera under a device display can improve gaze awareness in video communication and self-portrait videography, while increasing the useful display surface area and reducing the bezel. However, in these configurations the display structure is an ever-present obstruction between the scene and the camera. Incoming light diffraction off the display matrix may cause significant image degradation, including dimming, blurring, and flaring artefacts, and under-display (or otherwise obstructed) camera image rectification is a challenging computational problem. This can be especially true for high-contrast real-world photographic scenes where diffraction artefacts are exacerbated by sensor saturation.

One conventional approach to correcting blurring in an image is to measure the blurring effect induced by a particular configuration and then undo that blurring by a computational step known as deconvolution. For example, blurring caused by a camera system (and by other components, such as a display structure) can be characterized by a point spread function (PSF), which typically quantifies how a distant point of light is distributed onto the sensor array. If no blurring occurred, then an image of a point of light would appear as a point of light. However, degradation of the signal results in blurring, and a point-spread function represents this blurring function. In this approach, the blurred image is represented as the convolution of the input signal (i.e., a particular light source) with the measured PSF. Unblurring can then be approximated by deconvolving the blurred image with the PSF to obtain the true, unblurred input image. However, a measured PSF represents a measurement of a configuration at a particular point in time, and does not capture changes in the configuration over time. In addition, signal and measurement noise results in a measured PSF that is different than a “true,” noiseless PSF for a given configuration. In addition, the true response of a system often spatially varies, while a PSF is typically assumed to be the response of the system to a point of light, regardless of how that point of light moves relative to the sensor. For instance, a real-world camera system may have a PSF that varies across the field of view, such that a PSF measured at a particular point in the scene is insufficient to unblur the whole image. Finally, the response of the system may also vary as a function of the intensity of light incident on the system, and this functional relationship is not captured by a PSF measurement. In addition, characterization of a system's PSF typically occurs one time, e.g., after a device is manufactured and before that device is deployed.

The PSF is a specific example of the more general blurring operator, or corruption operator (which may also be referred to herein as a blurring function or corruption function), that represents degradation between a true, latent image and a captured imaged. Convolution is a specific example of a blurring operation, or corruption operation, and convolution has a particular mathematical definition. Although this disclosure refers in places to a point-spread function, in general it is possible to characterize corruption within a camera system from any image or series of images taken of a known source. This characterization can occur upon device manufacture for the sake of thoroughness or convenience, provided that the optical system remains approximately unchanged thereafter. Any such calibration necessarily has uncertainty associated with it. In the case of a high-dynamic range (HDR) PSF, this uncertainty could be quantitatively estimated to be proportional to the square root of the image intensity, as predicted by photon shot noise. Alternatively, the PSF or corrupting operator could be characterized analytically, with its uncertainty tied to the variable used to describe its analytical function. For example, for an Airy disc PSF that models the blurring caused by a circular aperture, the extent of diffraction (width and number of rings) and dispersion (chromatic shift) are analytical variables that fully characterize the PSF, and uncertainty in the Airy-disc PSF can be determined from the uncertainty in these underlying variables.

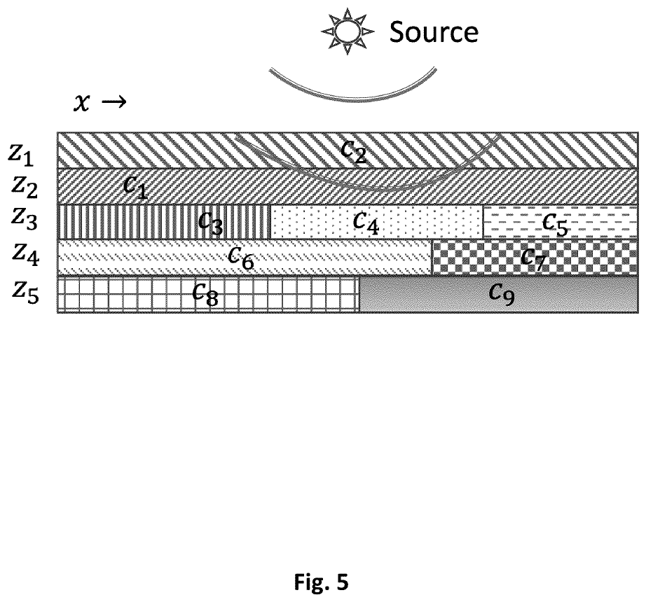

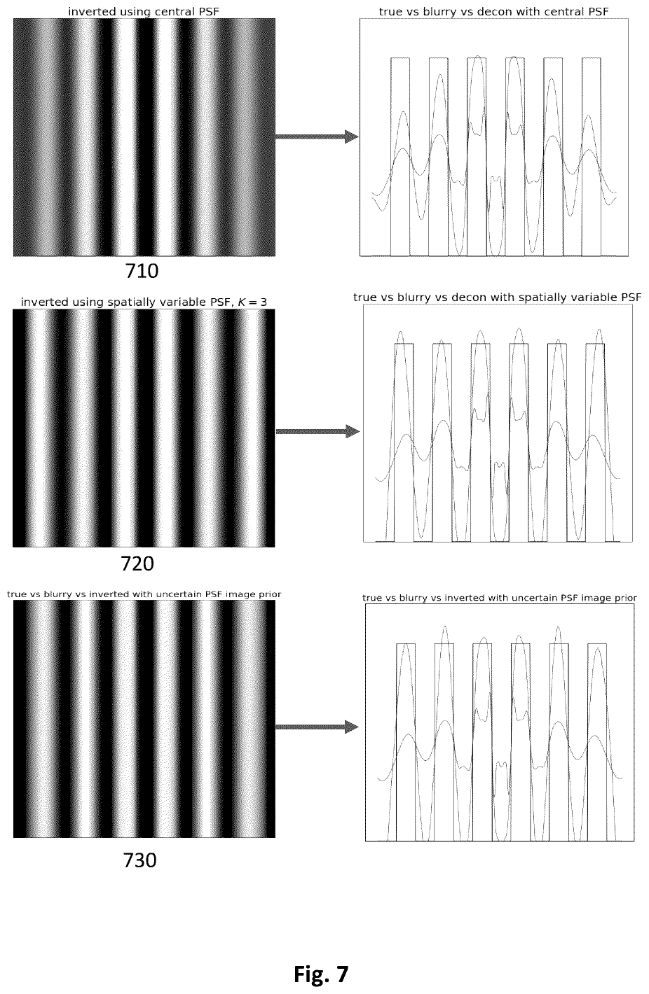

One challenge in the deconvolution process is the limited dynamic range of a camera sensor. The sensor output digitizes the amount of light reaching each pixel using a fixed number of bits, limiting the ratio between the brightest and the dimmest features that can be represented in the image. For example, if the sensor is a 10-bit device, the dimmest nonzero pixel value is 1 and the brightest possible pixel value is 1023. In many real-world scenes, information will be lost because dimmer features will appear completely dark and brighter features will be saturated due to the limited, discrete brightness values a pixel can take. This can particularly create problems for under-display cameras, since the side lobes of the extended PSF will saturate nearby pixels and cause a “flare” effect. High-dynamic-range (HDR) algorithms have been developed for consumer cameras that take into account information from multiple images to extend the dynamic range of the resulting photo beyond the intrinsic bit depth of the sensor to generate an HDR PSF, which more accurately describes the response of the system to incident light. For example, U.S. patent application Ser. No. 17/742,197 describes particular systems and method for generating an HDR PSF, (e.g., FIG. 5 of that application illustrates an example of the flaring degradation discussed above, FIG. 11 illustrates an example of using the PSFs corresponding to several images captured with varying exposure time to generate an HDR PSF, FIG. 7C illustrates an example process of generating an HDR image), and that description is incorporated by reference herein.

Although deconvolution of an HDR image by a previously measured HDR PSF can simultaneously perform some deblurring and reduce flare artefacts, the quality of the resulting image is extremely sensitive to corruption in the underlying signals. For example, the fidelity of the HDR images is ultimately limited by sensor noise, which itself is caused by technical and fundamental sources. For example, the quantum nature of light results in inherent photon shot noise that scales as the square root of the intensity of light striking the sensor; this contribution can dominate the observed noise in any well-designed optical system.

In particular circumstances, a corruption operator (e.g., a PSF) can spatially vary across an image. However, corruption operators, such as PSFs, are often modelled as being spatially invariant. As used herein, a corruption operator having spatial variance is referred to as a “non-stationary” corruption operator, while a corruption operator that is spatially invariant is referred to as a “stationary” corruption operator. Under-display cameras represent one application where PSF variation across the image limits the efficacy of deconvolution with a stationary PSF. For example, light entering the lens off-axis (e.g., near the edges of the image) experiences a different blurring function than light at the center of the image, due to the presence of the display structure. Multi-patch deconvolution, for example as described in U.S. patent application Ser. No. 17/742,197, using many recorded PSFs can mitigate imperfections in the reconstructed latent image, but this requires many measurements of the position-dependent PSF and add computational complexity.

In one example, an under-display-camera HDR blurring model may be described by a convolution operator (*) with an optical point-spread function (PSF) as:

d^{τ}^{ᵢ}=xₛₐₜ[τᵢf*x+ϵ_{d}^{τ}^{ᵢ}], i=1, . . . , N, (1)

where the left-hand side of (1) represents a raw low-dynamic-range image (sensor readings) corresponding to an exposure time τᵢ of a series of N shots; x is the true high dynamic range (HDR) image, and f is the camera HDR PSF that accounts for both incoming light diffraction off the display matrix and the intrinsic impulse response of the device imaging system; ϵ_{d}^{τ}^{ᵢ} is measurement noise, and the component-wise function χₛₐₜ models sensor saturation is:

$${χ}_{sat} [ x ] = \{ \begin{matrix}x , if x < c , \\ c , if x \geq c\end{matrix} \qquad ( 2 )$$

with a device-dependent saturation limit c. For example, for a 10-bit linear raw image, then c=1023. The objective is to recover an estimate of the true HDR image x from a set of noisy low-dynamic range images in the left-hand side of (1). While a non-linear inversion methodology may be applied directly to solve (1) for x, a more computationally efficient and statistically equivalent approach can be to solve:

d=f*x=ϵ_{d}, (3)

where d is a blurry HDR image obtained as a weighted average of raw low-dynamic range shots, and ϵ_{d} is HDR image noise with the statistics derived from ϵ_{d}^{τ}^{ᵢ} in (1). Although the HDR PSF f can be computed numerically given the relevant parameters of the optical system and display matrix, in practice parameter uncertainties result in a significant departure of the simulated PSF from the actual device response. A more robust approach is to estimate the HDR PSF from multiple low-dynamic range PSF measurements:

g^{τ}^{ᵢ}=χₛₐₜ[τᵢh*f+ϵ_{g}^{τ}^{ᵢ}], i=1, . . . , M, (4)

where the left-hand side of (4) represents a raw low-dynamic-range images corresponding to exposure times τᵢ of a series of M independent shots; h is the Airy function, and ϵ_{g}^{τ}^{ᵢ} is measurement noise. Once an estimate of f is available, the true HDR image x may be obtained by deconvolving the blurry HDR image d with f, for example as described in U.S. patent application Ser. No. 17/742,197. Equations (1) through (4) describe aspects of a UDC blurring model described in U.S. patent application Ser. No. 17/742,197, with d representing the blurry image, f the HDR PSF, χₛₐₜ the saturation function, ϵ_{d} the sensor noise, and g the images making up the image stack for determining the HDR PSF. In the example above, all lowercase bold letters denote n×m matrices and represent monochromatic images. All arithmetic operations are applied component-wise.

The approach in the example above makes the following assumptions: (1) the PSF is spatially invariant within the image; (2) the variance of the pixel intensity readout is presumed to be constant (homoscedastic noise); and (3) the actual illumination of the high-intensity pixels is calculated correctly from the lowest-exposure-time images. A consequence of assumptions (1) and (2) is that deconvolution can be performed in the Fourier domain, which improves computation speed. In practice, however, the quality of the recovered image is limited by violations of one or more of these assumptions, resulting in image artifacts such as residual glare or other corruption of the image.

While the discussion immediately above relates to an example of noise in the context of HDR PSFs, the corrupting effect of noise is present in all images captured by a camera. In other words, there is inherent randomness in the amount of light that hits each pixel of a camera's sensor, and even if very careful measurements are made, there will still be some uncertainty in the resulting image. Small imperfections (“noise”) in a blurring operator (e.g., a PSF) can have a large impact on image quality. In addition, approaches to addressing noise generally assume that pixel readout noise is independent of the light intensity measured by that pixel (homoscedastic noise), whereas in real life the observed noise is quite likely to be related to the measured value (heteroscedastic noise). For example, one feature of shot noise is that the uncertainty of the light intensity on each camera pixel increases as the intensity increases. In other words, the noise is not constant for all pixels: it is higher for the brightest pixels, which, for example, are the ones that most strongly contribute to flare artefacts. More generally, a corruption operator has an uncertainty associated with each pixel, and that uncertainty can, and likely is, different for different pixels.

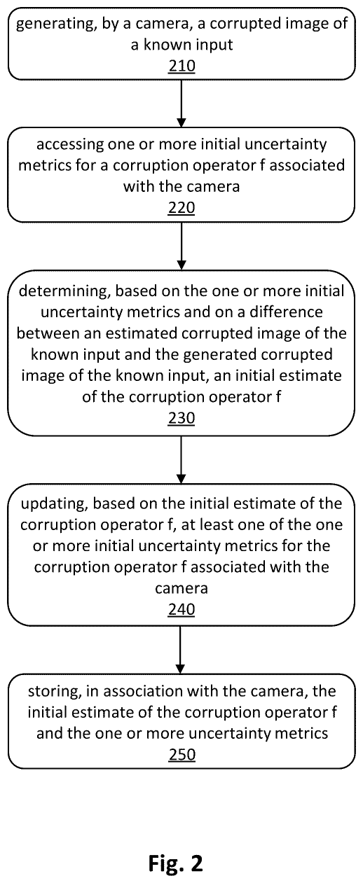

Particular embodiments of this disclosure take into account that an unknown, captured image or images (e.g., a set of images used to create an HDR image) and the corruption operator describing a system are drawn from a statistical distribution of possible images and operators, respectively, including distributions that reflect the effects of noise. Particular embodiments of this disclosure frame image correction (e.g., deconvolution) as an optimization process that takes into account these statistical distributions. Moreover, particular embodiments of the methods described herein correct for image corruption induced by more advanced operators than what can be described by convolution with a stationary PSF—including nonlinear corrupting operators or corruption in a nonlinear color space (such as YUV). Moreover, because particular embodiments described herein estimate a corrupting operator in real-time, such embodiments can address gradual changes in the corruption operator that may occur after the initial calibration of the camera system (e.g., as described in the example of FIG. 2). Moreover, particular embodiments described herein infer a corrupted image all at once, even when different regions of the image are affected by different corruptions.

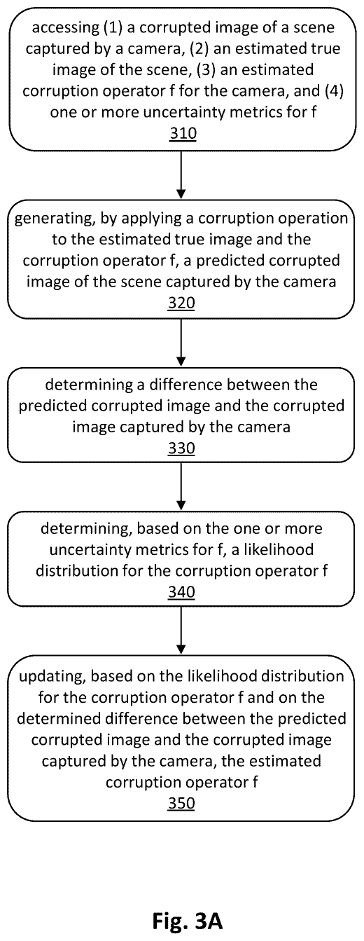

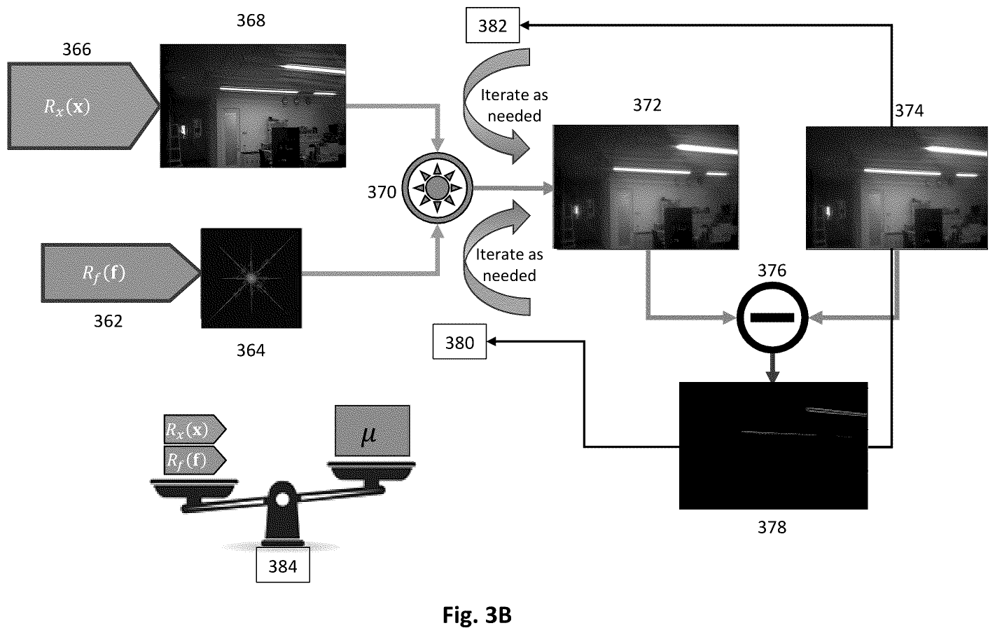

For the methods and systems of this disclosure, the quantity of interest is input into an optical or another signal-processing system that produces corrupted output that depends on both the input and the system's inherent “corruption operator” that is imperfectly known (e.g., due to noise). As explained more fully below, the approach in the example methods of FIGS. 2 and 3A-B can be described conceptually as 1) measuring corrupted output for known input and then quantifying the corruption operator and its uncertainty from the measured output, and 2) using the result including the uncertainty to estimate a corrupted image of an unknown true input, which is then used to update the estimate of the corruption operator and its uncertainty . Step 1 corresponds to the example method of FIG. 2, below, while step 2 corresponds to example method of FIG. 3A, below. As described more fully below, step 1 may be performed one time (e.g., before device deployment) for a particular camera system, while step 2 may be performed in real-time for each image subsequently captured by that camera system.

A system captures an actual signal (a “true” or “latent” signal (e.g., image signal) x) and yields a corrupted signal d. For example, d could be a low-dynamic range image of a true photographic scene x; f could the high-dynamic range convolution operator in equation (1), and the corrupted output d may then described by a conditional probability distribution:

d˜p(d|x, f, θ) (DIST)

where the symbol “˜” means that the left-hand side is a random variable distributed according to the conditional probability distribution in the right-hand side, and θ is a vector of additional parameters (for example, parameters such as exposure times and sensor noise characteristics). Where this does not cause confusion, particular embodiments disclosed herein assume θ to be implicit and the corresponding disclosure therefore drops θ from the parameter list.

A computationally efficient way of modeling corruption d of a test image x given x, f, θ may be designated by:

d=F(x, f, θ), (GEN)

where the generative model (GEN) provides a way of sampling d from (DIST) including additive or multiplicative noise. One distinction between f and θ in this model is that f estimates the system's non-volatile characteristics but may be initially unknown or inaccurate, while θ may represent parameters that vary between image captures (such as exposure times) that in most cases of interest may be known.

By observing corruptions of a known image x₀,

g˜p(g|x₀, f, θ), (KNOWN_IM)

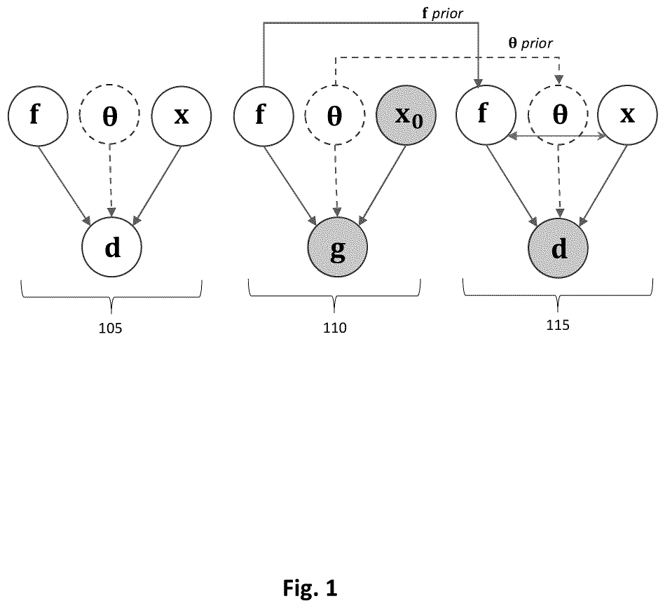

f can be estimated via its corresponding posterior distribution (FIG. 1, element 110). The same approach can be applied, e.g., simultaneously or sequentially, to θ should those parameters need estimation. Then, upon obtaining an unknown image x, the resulting stochastic estimates (posterior distributions) can be used as prior information and combined with observations (DIST) of x to jointly estimate x, f and, optionally, θ. Here, observation of a “common descendant” d makes the a-priori independent x and f and, optionally, θ conditionally dependent (FIG. 1, element 115) with a non-trivial conditional joint probability distribution. In particular embodiments, estimating any such probability distributions means estimating a maximum-likelihood value of the corresponding random quantity and its associated variance (uncertainty).

FIG. 1 illustrates three Bayesian elements used by particular embodiments of this disclosure. In FIG. 1, grey nodes indicate measured or known quantities. Element 105 illustrates a step that assumes the existence of a way of modeling corruption d of a test image x given x, f, θ. In element 105, x, f, θ are a-priori independent and d is a simulated and/or predicted corruption of a test image. Element 110 illustrates a step in which corruption of a known image is measured. This yields a posterior probability distribution for image corruption operator f (and optionally θ) from observed corruptions g of a known true image x₀ and uses the result as “prior information” about f (and optionally θ). Here, f is an operator that is determined by an estimated parameter vector. In element 110, g is an observed corruption of a known image (as discussed more fully in connection with, e.g., FIG. 2, below); for example, a measured PSF. Element 115 illustrates simultaneously estimating a posterior probability distribution for true image x and corruption parameter vector f (and optionally θ) from observed corrupted image d and the prior information about f (and optionally θ). In element 115, x, f, θ are conditionally dependent once d is observed, and d is an observed corruption of an unknown image (as discussed more fully in connection with, e.g., FIG. 3A, below). In other words, once the observed corruption of an unknown image is measured, estimates of the true corruption operator and the latent image are interrelated, such that the revision of one necessitates the revision of the other as well. Moreover, in revising f and x, one must take into account the likelihood of the resulting estimate as quantified by the prior information and its uncertainty. The approaches of FIG. 1 can be described as Bayesian estimation of the posterior probability p(x, f|d, θ) or, optionally, p(x, f, θ|d) from the conditional distributions of observed corrupted signals in (DIST) and (KNOWN_IM). Using these approaches subsequently involves calculating the probability that estimates for the latent image x and the corruption operator f yield the observed corrupted image d. The likelihood of these estimates being accurate (i.e., of x representing the true scene, and off representing the true corruption introduced to the image) can then be maximized by refining the estimations of the latent image and its corruption operator while taking into account the quantitative uncertainties in both.

An example implementation using the Bayesian approach described above is as follows. Given M observations of corrupted images G={gⁱ}₁^{M}={g¹, g², . . . , g^{M}}, gⁱ=g^{τ}^{ᵢ} of one or more known images (e.g., observations of low-dynamic range blurry images of a point source with varying exposures τᵢ), and N observations of corrupted images D={dⁱ}₁^{N}={d¹, d², . . . , d^{N}}, dⁱ=d^{τ}^{ᵢ} of an unknown scene (e.g., low-dynamic range degraded or blurry images of a certain photographic scene taken with varying exposures), particular embodiments estimate the unknown true image (e.g., the undistorted photographic scene) x and the parameters that describe the corruption operator f (e.g., HDR PSF) by maximizing the joint probability distribution:

p(D, G, x, f)=p(D|x, f)p(x)p(G|f)p(f), (5)

where both x and f are allowed to vary. In essence, equation (5) quantifies that the joint probability of having a mutually consistent set of the following: an observed set of corrupted images D of the unknown true image x, observed set of corrupted images G of some known image(s), likelihood (marginal) distribution of the true image x and likelihood distribution of the parameter vector f describing the corrupting operator. Given the observations D and G, particular embodiments find the true x and f that maximize this probability. An advantage of this approach is that it takes into the account the uncertainty in the estimate of the corruption operator (e.g., PSF) f through the joint probability p(G, f)=p(G|f)p(f). Since the individual measurements are conditionally independent given fixed x and f, for the conditional probabilities in the right-hand side of (5):

p(D|x, f)=Πᵢ₌₁^{N}p(dⁱ|x, f), (6)

p(G|f)=Πᵢ₌₁^{M}p(gⁱ|f). (7)

Since the system configuration (display structure, lenses, sensor, etc.) for an image-capturing system does not change or changes very little over time, the initial estimation of the parameter vector f (denoted as f₀) can be performed as a one-time process, and the number of corrupted images M can be very large, M>>N. FIG. 2 illustrates an example of this process. The number N of raw images dⁱ, on the other hand, is limited by operational constraints of the device (e.g., a mobile or other client computing device), and typically N<10. For example, a smartphone camera has a limited amount of time to take an HDR photo. FIG. 3A illustrates an example of this real-time process involving N unknown images.

A fixed observation of D in p(D|x, f) results in a conditional dependence between x and f. Any multi-exposure set of raw images contains information about both the photographic scene being captured and the optical PSF that causes image degradation. The large number M>>N of terms in the product (7) results in a significant computational complexity of minimizing (5). The posterior probability may be estimated as:

$$p ( f \vert G ) = \frac{p ( G \vert f ) p ( f )}{p ( G )} ∝ p ( G , f ) , \qquad ( 8 )$$

with a tractable proposal distribution q(f)≈p(f|G) in a one-off calculation, then substituting this distribution in (5) results in:

x, f=argmax p(D|x, f)p(x)q(f). (9)

Equations (5) through (9) set up estimation of the corrupting operator f (e.g., PSF) and the true image/scene x as the estimates that maximize joint probabilities.

Particular embodiments recast the discussion above as a computational problem, for example, substituting equation (9) with an equivalent optimization problem:

x, f=argmin (Σᵢ₌₁^{N} μ(F₀(x, f, θⁱ), dⁱ, F₀(x, f, θⁱ))+Rₓ(x)+R_{f}(f)) (OPT)

where the first term on the right-hand side of the equation corresponds to −ln p(D|x, f), the second term corresponds to −ln p(x), and the third term corresponds to −ln q(f).

In equation OPT, F₀ is a generator of corrupted signals as in (GEN) that may or may not include noise generation; θⁱ, i=1, . . . , N are signal (image) capture parameters (for example, exposures); μ(x, y, z) is a measure of misfit between the first two arguments that depends on the third argument (i.e., in equation OPT, μ is a measure of misfit between F₀ and dⁱ that depends on F₀), and for example, this dependence may encode a noise model where noise is heteroscedastic and depends on the signal amplitude; R_{f} is a regularization (or penalty) term for the parameter vector f and Rₓ is a regularization term for the unknown signal x. Equation (9) can be reduced to (OPT) by taking the negative logarithm of the right-hand side (i.e., minimizing negative log-likelihood instead of maximizing probability). The regularization term R_{f} effectively represents both the prior information about f obtained from observing corruptions of a known image in (KNOWN_IM) and, crucially, it's also the uncertainty of any such estimate. Note this step implicitly introduces a “proposal distribution” q(f)≈(f|G) of (9) e.g.:

$$- ln q ( f ) = {R}_{f} ( f ) = \frac{1}{2} {( f - {f}_{0} )}^{*} {C}^{- 1} ( f ) ( f - {f}_{0} ) , \qquad ( REG\_F )$$

where C(f) is a covariance matrix for parameter vector f, f₀ is the solution of:

f₀=argmin Σᵢ₌₁^{M} μ(F₀(X₀, f, θ₀ⁱ), gⁱ, F₀(x₀, f, θ₀ⁱ))+R_{f}⁰(f) (EST_F)

where θ₀ⁱ, i=1, . . . , M>>N are signal (image) capture parameters for an a-priori known signal x₀, R_{f}⁰(f) is a regularization term representing prior information about the corruption operator parameter vector f, for example:

$${R}_{f}^{0} ( f ) = \frac{1}{2} {( f - {f}_{A} )}^{*} {C}_{A}^{- 1} ( f ) ( f - {f}_{A} ) , \qquad ( REG 0 \_F )$$

where f_{A} and C_{A}(f) come from an existing mathematical model of the corruption operator or from earlier measurements of the corruption operator.

Equations (OPT) through (REG0_F) specify how the likelihood-maximization problem (9) can be explicitly cast as an optimization problem that reduces a measure μ of misfit while taking into account prior information about what kinds of latent images and corrupting operators are most probable.

The covariance matrix C(f) may be obtained empirically, analytically, or numerically. In the latter case, it can be computed as the inverse Hessian (matrix of second-order derivatives) with respect to the elements of f evaluated at the minimum f₀ of (EST_F). In particular embodiments, C(f) may be approximated with its diagonal elements, reducing (REG_F) to:

$${R}_{f} ( f ) = \frac{1}{2} {\sum }_{k = 1}^{n} \frac{{( {f}^{k} - {f}_{0}^{k} )}^{2}}{{σ}_{{f}^{k}}^{2}} \qquad ( REG D\_F )$$

where σ_{f}_{^{k}}² is the variance of the k^{th} component of f that quantifies the uncertainty in the estimate of the individual components of f₀, and n is the number of components in f. The regularization terms Rₓ(x) in (OPT) expresses any prior information about the unknown signal of interest, including prior information from domain knowledge. In many problems of interest, it is picked to penalize undesirable effects such as high-frequency oscillations, as in a Tikhonov regularization:

Rₓ(x)=α∥∇^{l}x∥₂², l≥1, (REG_X)

where Δ is the discrete Laplace operator applied to x represented as a 2-dimensional matrix, and α>0 is an empirically selected regularization strength. Other options relevant for image applications include:

Rₓ(x)=α∥x∥₁ (REGL1_X)

for recovering a sparse x (e.g., an image of point-like objects), and include:

Rₓ(x)=α∥∇x∥₁ (REGTV_X)

for recovering “blocky” signals, especially where capture resolution exceeds the size of the details of interest. Equations (REGD_F) through (REGTV_X) provide examples of regularization operators that, when included in equation (OPT), encapsulate prior expectations (e.g., domain knowledge) about image characteristics and corruption types that are most likely.

This disclosure is not limited to a particular method of solving the optimization problems (OPT) and (EST_F), nor to a specific technique of quantifying the uncertainty of the estimated f₀, or to a particular analytical or numerical representation of that uncertainty, of which (REG_F) and (REGD_F) are examples. This disclosure is likewise not limited to a particular type of prior information about the unknown signal and corruption parameters, and equations (REG_F0), (REG_X), (REGL1_X), (REGTV_X) provide some specific but not exhaustive examples. As explained in connection with example method of FIG. 3B, embodiments of this disclosure apply generally to circumstances in which both x and f can be generated or sampled in such a way that the corresponding penalties Rₓ(x), R_{f}(f) and the misfit μ can be computed in real time. Such sampling can be part of a particular computational method of solving (OPT) and (EST_F) using a deterministic approach (e.g., differentiable multivariate nonlinear optimization), stochastic approach (e.g., Monte Carlo sampling), or broadly generative approach (e.g., NN generative models, sampling from a known ansatz or functional form, selecting parameters from a lookup table, etc.).

FIG. 2 illustrates an example method for determining an initial estimate of a corruption operator f for a camera and one or more uncertainty metrics for the corruption operator f. The example method of FIG. 2 may be performed a single time for a particular camera, e.g., by a manufacturer of the camera prior to the camera's deployment (e.g., a deployment of the device in which the camera is incorporated). In particular embodiments, the example method of FIG. 2 may be performed for a specific instance of a device (e.g., a specific device model), and the resulting corruption operator f and uncertainty metrics may be used for all instances of that device. In particular embodiments, the example method of FIG. 2 may be performed for each instance of a device, e.g., prior to device deployment. In particular embodiment, the example method of FIG. 2 may be performed for each camera on a device (e.g., a wide-lens camera, a primary camera, etc.).

Step 210 of the example method of FIG. 2 includes generating, by a camera, a corrupted image of a known input. The “camera” may be any set of image-generating components for creating images, such as a lens, sensor (e.g., an optical sensor, infrared sensor, etc.), a display mask (e.g., for an under-display camera), etc. Here, “a camera” may include multiple sensors (e.g., RGB sensors) used to create an image. The example of method of FIG. 2 therefore generates an initial corruption operator f and corresponding one or more uncertainty metrics for a specific set of image-generating components of a device.

Step 210 may include generating a number of corrupted images of a known input. For example, step 210 may include generating M images of a known scene, as described more fully herein. In particular embodiments, the M images may be associated with different exposure times or gain values, for example to generate an HDR image.

Step 220 of the example method of FIG. 2 includes accessing one or more initial uncertainty metrics for a corruption operator f associated with the camera. As explained herein, the one or more initial uncertainty metrics may include R_{f}(f), and the initial uncertainty metrics may be represented by equation (REG0_F), although this disclosure contemplates that the one or more initial uncertainty metrics may include other prior information about the corruption operator parameter vector f.

Step 230 of the example method of FIG. 2 includes determining, based on the one or more initial uncertainty metrics and on a difference between an estimated corrupted image of the known input and the generated corrupted image of the known input, an initial estimate of the corruption operator f. For example, the initial estimate of the corruption operator f may be determined to be f₀ as given by equation (EST_F), above. As discussed herein, the initial estimate of the corruption operator f may be based on M corrupted images of the known input. In particular embodiments, step 230 of the example method of FIG. 2 includes accessing one or more image-capture parameters θ , and the initial estimate of the corruption operator f is further determined based on the one or more image-capture parameters θ (such as, e.g., image-capture exposure times). As illustrated by, for example, equation (EST_F), the one or more image-capture parameters θ may be determined for each of M images used to estimate the corruption operator f. In particular embodiments, a determination of the initial estimate of the corruption operator f may be based on one or more regularization terms (e.g., a term that penalizes a polynomial fit of relatively high order) and/or on one or more statistical priors, in addition to the one or more uncertainty metrics (which includes, e.g., noise estimates).

Step 240 of the example method of FIG. 2 includes updating, based on the initial estimate of the corruption operator f, at least one of the one or more initial uncertainty metrics for the corruption operator f associated with the camera. Equation (REGD_F) illustrates an example of updating initial uncertainty metrics based on the initial estimate of the corruption operator f.

Step 250 of the example method of FIG. 2 includes storing, in association with the camera, the initial estimate of the corruption operator f and the one or more uncertainty metrics. For example, the initial estimate and the uncertainty metrics may be stored locally on the electronic device that includes the camera for which FIG. 2 is being performed. For example, the initial estimate and the uncertainty metrics may be stored locally on a smartphone when the camera of interest is a camera on that smartphone. In particular embodiments, the initial estimate and the uncertainty metrics may be stored on a remote device, such as a server device or another client computing device. The initial estimate and the one or more uncertainty metrics may subsequently be used for real-time correction of an image captured by that camera, for example as described in connection with the example method of FIG. 3A.

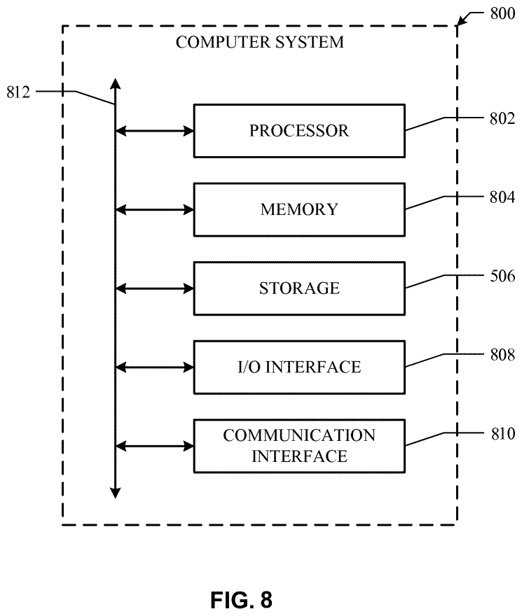

Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates particular components, devices, or systems carrying out particular steps of the method of FIG. 2, such as the computer system of FIG. 8, this disclosure contemplates any suitable combination of any suitable components, devices, or systems carrying out any suitable steps of the method of FIG. 2. Moreover, this disclosure contemplates that some or all of the computing operations described herein, including the steps of the example method illustrated in FIG. 2, may be performed by circuitry of a computing device, for example the computing device of FIG. 8, by a processor coupled to non-transitory computer readable storage media, or any suitable combination thereof.

FIG. 3A illustrates an example method for updating a corruption operator f in real-time in order to correct one or more corrupted unknown images taken by a camera system. Step 310 of the example method of FIG. 3A includes accessing (1) a corrupted image of a scene captured by a camera, (2) an estimated true image of the scene, (3) an estimated corruption operator f for the camera, and (4) one or more uncertainty metrics for f. In particular embodiments, the corrupted image of the scene includes N corrupted images of the scene, for example images that have been captured with different exposure times, e.g., in order to create an HDR image of the scene. In particular embodiments, the estimated corruption operator f or the one or more uncertainty metrics for f, or both, accessed in step 310 may be the operator and uncertainty metrics stored for this camera as a result of the process of FIG. 2. In particular embodiments, the estimated corruption operator f or the one or more uncertainty metrics for f, or both, accessed in step 310 may be the operator and uncertainty metrics as determined by a previous instance of the method of FIG. 3A.

This disclosure contemplates that the corruption operator f and the one or more uncertainty metrics may take any suitable form. For example, the corruption operator f may be a pseudo-differential operator, a non-stationary operator, or a point-spread function, or any other corruption operator described herein.

In particular embodiments, the example method of FIG. 3A may be performed for a camera that is disposed behind a display structure, which as discussed above, may cause image corruption that is represented by the corruption operator f.

Step 320 of the example method of FIG. 3A includes generating, by applying a corruption operation to the estimated true image and the corruption operator f, a predicted corrupted image of the scene captured by the camera. For example, the corruption operation may be a convolution operation when the corruption operator f is a point-spread function.

Step 330 of the example method of FIG. 3A includes determining a difference between the predicted corrupted image and the corrupted image captured by the camera. As described herein, this disclosure contemplates that any suitable difference metric may be used to determine the difference between two images.

Step 340 of the example method of FIG. 3A includes determining, based on the one or more uncertainty metrics for f, a likelihood distribution for the corruption operator f. For instance, as discussed above in connection with equation (REG_F), the term R_{f}(f) represents uncertainty in the estimate off and is related to the proposal distribution q(f) discussed above by −ln q(f)=R_{f}(f). In particular embodiments, such as in equation (OPT), a likelihood distribution for the corruption operator f may not be explicitly or directly determined, but rather may be determined by accessing or determining the regularization term R_{f}(f).

Step 350 of the example method of FIG. 3A includes updating, based on the likelihood distribution for the corruption operator f and on the determined difference between the predicted corrupted image and the corrupted image captured by the camera, the estimated corruption operator f. For example, the estimated corruption operator f may be determined by the equation (OPT) discussed above, without the image-regularization term Rₓ shown in that equation if the estimated image x is not being simultaneously updated, or with that regularization term included (i.e., taking into account the probability associated with estimated image) if the estimated image x is being simultaneously updated.

As discussed herein, particular embodiments of the example method of FIG. 3A may also include taking into account a probability associated with the estimated image. For example, such embodiments may include accessing one or more image priors for the corrupted image of the scene captured by the camera, e.g., image priors Rₓ(x), which may be any suitable prior information including but not limited to the specific regularization examples Rₓ(x) discussed herein. In particular embodiment, accessing an estimated true image of the scene in step 310 of the example method of FIG. 3A includes generating, based on the one or more image priors, the estimated true image. For example, the image prior(s) may be used to impose probabilistic constraints on the distribution of all possible estimated true image and/or on the distribution of one or more characteristics of such images. As discussed herein, at least some image priors that may be used in connection with an implementation of the example method of FIG. 3A may be based on one or more characteristics of the scene, as determined by the corrupted image captured by the camera. For example, for an image that appears to be of a bar code, image priors specific to bar-code type images may be accessed and used, while different image priors may be used for a scene that appears to be of a person or of a natural environment.

As discussed herein, in particular embodiments the estimated true image of the scene may be updated along with the update of the corruption operator f, for example by balancing (e.g., as per equation (OPT)) minimization of the difference between the estimated blurred image and the true image with the probability distributions associated with f and the probability distribution associated with the estimated true image x. In other words, the difference between an estimated corrupted image and the obtained corrupted image is not minimized without regard to how likely the corresponding estimates for the corruption operator or estimated image are, e.g., a highly unlikely estimate of the corruption operator is not used merely because it would result in the minimum difference between the estimated image and the capture image. Nor is the most probable corruption f or the most probable estimated image x used without regard to how using those estimates compares to the captured corrupted image. Instead, the corruption operator f (and, in particular embodiments, the estimated true image x) are determined in real-time using a holistic approach that takes into account the probability associated with those estimates along with the resulting corrupted image that would occur, in comparison to the corrupted image that was actually captured.

The example method of FIG. 3A (and, in particular embodiments, the corresponding updates of the estimated true image x) may be iteratively performed until some stopping condition is met. For example, a stopping condition may be any of (1) that the difference between the predicted corrupted image and the corrupted image captured by the camera is less than a difference threshold, (2) that a change between two iterations in the difference between the predicted corrupted image and the corrupted image captured by the camera change is less than a convergence threshold, or (3) an iterative threshold is reached. In particular embodiments the stopping condition used, or the corresponding threshold(s) (or both) may depend on the device used, the usage conditions, or both. For example, a device with relatively low computing power or remining battery power may have a relatively low iterative threshold. As another example, a captured image that a user is attempting to immediately access (e.g., to view or send the image) may result in a relatively more stringent stopping conditions than a use case in which the user is not attempting to access a captured image.

In particular embodiments, the corruption operator f or uncertainty metrics (or both) determined at the end of the example method of FIG. 3A (and any subsequent iterations) may be stored for subsequent use. For example, a camera system may change over time (e.g., since the method of FIG. 2 was performed for that system), e.g., as a result of physical conditions (e.g., the camera was dropped, or a smudge is on a lens) or as a result of aging or wear and tear, and the updated estimates for the corruption operator f and associated uncertainty metrics may reflect changes to the camera system that alter the corruption caused by that camera system.

FIG. 3B illustrates an example graphical illustration of an embodiment of the example method of FIG. 3A. In the example of FIG. 3B, priors 362 (e.g., R_{f}(f)) for the corruption operator f are accessed and used along with an initial estimate 364 of the corruption operator f to blur, or corrupt, an estimated image 368 according to a corruption operation 370. In the example of FIG. 3B, the estimated image 368 is determined based on one or more image priors 366 (e.g., Rₓ(x)). The result of corruption operation 370 is an estimated corrupted image 372, which is compared 376 with a captured corrupted image 374 to determine a difference 378, according to a difference metric μ. Then, the estimated corruption operator f is adjusted 380 and the estimated true image 368 is adjusted 382 taking into consideration 384 the value of the difference metric μ and the priors (e.g., probability constraints on) on the estimated corruption operator f and the estimated true image x. The process is iterated as needed, e.g., until a stopping condition is reached. As described herein, x and f may be updated simultaneously in each iteration, or these values may be updated sequentially (e.g., one iteration updates f, while the next iteration updates x, and so on).

In particular embodiments, an initial estimate for an unknown image x may be obtained from a previously performed measurement, for example by deconvolution with a previously estimated HDR PSF. In particular embodiments, a gradient descent method may be used to minimize the OPT equation. For example, particular embodiments may parameterize a corruption operator by a number of parameters pᵢ, and the derivatives ∂μ/∂pᵢ may be determined, along with how the variation of the parameters pᵢ affects the corruption operator to make it more or less likely, according to its probability distribution. Thus, the parameters pᵢ can be adjusted to balance the minimization of μ and the likelihood of the estimate of the corruption operator. The same process can be performed simultaneously, or in sequence, for the latent image.

As illustrated in FIG. 3B, particular embodiments adjust both the estimate of the latent image and the corruption operator when minimizing the difference μ. In particular embodiments, this adjustment may happen simultaneously (i.e., in the same iteration). In particular embodiments, the adjustment may occur in sequence (i.e., in one iteration x is held constant while f is adjusted, while in the next iteration x is adjusted while f is held constant).

In particular embodiments, a corruption operator may be modified directly during an adjustment iteration. For example, if a corruption operator such as a PSF is compact (for example a 3 pixel by 3 pixel image), the PSF image may be modified directly, for example by performing a random search. By making some pixels of the PSF brighter and others darker, such embodiments can determine which formulation of the PSF minimizes the argument of equation OPT.

In particular embodiments, a corruption operator may be modified using gradient methods. For example, such embodiments may analytically or numerically calculate how variation of the corruption operator changes the image, and then use techniques such as gradient descent, projected/proximal gradient descent, stochastic gradient descent, or Alternating Direction Method of Multipliers (ADMM). As one example, a PSF corruption operator with extensive flare side lobes will produce stronger and longer-distance flare artefacts in the output image. If the predicted output image shows longer-distance flare features than the measured image, then the PSF may be modified by reducing the extent of the side lobes in the PSF or, conversely, increase the intensity of its central region. This approach may be implemented quantitatively.

If a corruption operator is relatively complex, then particular embodiments may rely on an underlying model to parameterize the corruption operator according to some limited number of variables. For instance, for an under-display camera, a physics-based simulation can predict the corruption operator from the structure of the display in front of the camera. The structure of the display is a regular pattern that can be described by a small number of variables. Using the physics model, such embodiments can vary those display parameters, calculate the effect on the corruption operator, and propagate the results through to the predicted image. For example, a wave-optics simulation can be based on a simplified model of an under-display camera structure that is parameterized with only two parameters: pixel island size (e.g., a square having 250 μm sides) and interconnecting wire width (e.g., 50 μm). Even though the calculated corruption operator for this structure may be quite large (e.g., more than 100 pixels by 100 pixels on the camera sensor), it can be characterized as the result of only two underlying parameters. Thus, when adjusting this corruption operator, particular embodiments only need to adjust the two underlying parameters, not each of the more than 10⁴ pixels in the calculated corruption-operator image. As this example illustrates, parameterizing the corruption operator according to a physical model based on a limited set of variables can reduce the computational burden to ensure that the OPT algorithm converges on the optimal PSF that minimizes misfit μ while yielding a latent image that satisfies the latent image priors. This adjustment of the corruption operator is performed within the bounds of the estimated PSF and its uncertainty: for example, if manufacturing tolerances specify that under-display camera pixels are 250±20 μm, one would not choose an “optimal” corruption operator having 1 mm pixels, even if that operator yields the smallest misfit μ.

Particular embodiments may repeat one or more steps of the method of FIG. 3A, where appropriate. Although this disclosure describes and illustrates particular steps of the method of FIG. 3A as occurring in a particular order, this disclosure contemplates any suitable steps of the method of FIG. 3A occurring in any suitable order. Moreover, although this disclosure describes and illustrates particular components, devices, or systems carrying out particular steps of the method of FIG. 3A, such as the computer system of FIG. 8, this disclosure contemplates any suitable combination of any suitable components, devices, or systems carrying out any suitable steps of the method of FIG. 3A. Moreover, this disclosure contemplates that some or all of the computing operations described herein, including the steps of the example method illustrated in FIG. 3A, may be performed by circuitry of a computing device, for example the computing device of FIG. 8, by a processor coupled to non-transitory computer readable storage media, or any suitable combination thereof.

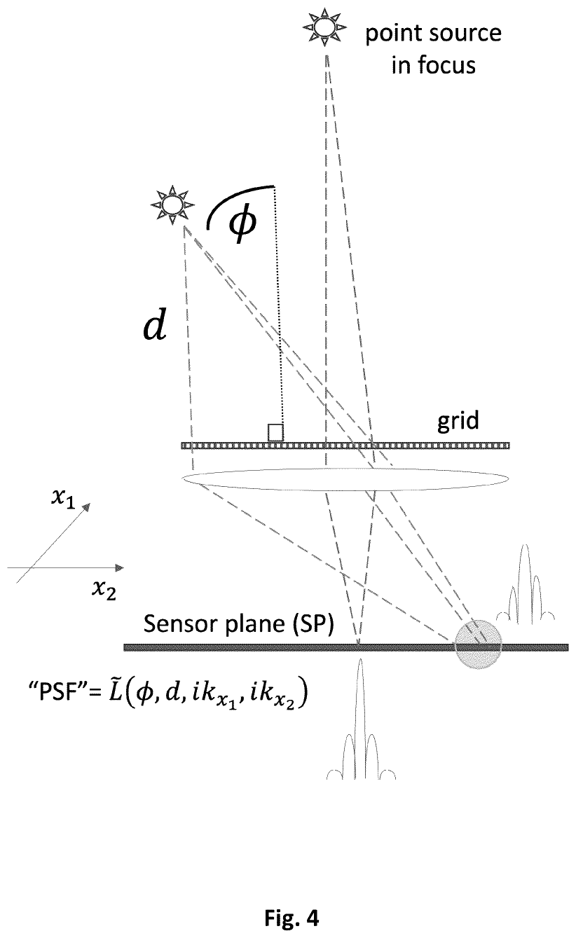

Particular embodiments of this disclosure are characterized by a non-stationary signal propagation. For instance, non-stationary propagators arise in optical systems when, for example, estimates of the point-spread function depend on the angle between a pixel and a point source, as described more fully above. Embodiments characterized by a non-stationary signal propagation may use a specific class of generative (corruption) operators (GEN) and misfit measures μ described below. For example, the effect of an angle (and distance) dependent PSF can be expressed mathematically as a non-stationary convolution operator in the image space (e.g., on a device sensor plane with coordinates x₁, x₂) defined using the Fourier transform F[] as:

$$L ( \begin{matrix}2 & 2 & 1 & 1 \\ {x}_{1} , & {x}_{2} & \frac{\partial }{\partial {x}_{1}} , & \frac{\partial }{\partial {x}_{2}}\end{matrix} ) u ( {x}_{1} , {x}_{2} ) := {F}^{- 1} [ L ( {ξ}_{1} , {ξ}_{2} , {ik}_{x} , {ik}_{y} ) F [ u ( {x}_{1} , {x}_{2} ) ] ( {k}_{x} , {k}_{y} ) ] {\vert}_{\begin{matrix}{ξ}_{1} = {x}_{1} , \\ {ξ}_{2} = {x}_{2}\end{matrix}} \qquad ( PDO )$$

where u(x₁, x₂) is the true (uncorrupted) signal, kₓ_{₁}, kₓ_{₂} are the spatial wavenumbers, and the “pseudo-differential operator” or “PDO” L( ) is expressed, for example, via the angle-dependent PSF \tilde{L}( ) illustrated in FIG. 4 (which illustrates a point source for which distortion varies at different angles) as:

$$L ( \begin{matrix}2 & 2 & 1 & 1 \\ {x}_{1} , & {x}_{2} & \frac{\partial }{\partial {x}_{1}} , & \partial / \partial {x}_{2}\end{matrix} ) = L ( {x}_{1} , {x}_{2} , {ik}_{{x}_{1}} , {ik}_{{x}_{2}} ) = \tilde{L} ( ϕ ( {x}_{1} , {x}_{2} ) , d ( {x}_{1} , {x}_{2} ) , {ik}_{{x}_{1}} , {ik}_{{x}_{2}} ) \qquad ( PSF\_PDO )$$

Pseudo-differential operators are not limited to examples of angle-dependent PSF as in (PSF_PDO) and FIG. 4. An example of reflection-free transmission of electromagnetic waves through a heterogeneous layered medium with varying propagation velocity c(x, z) is illustrated in FIG. 5. Reflection-free transmission of electromagnetic waves through a heterogeneous layered medium can be adequately described in many applications by a one-way Helmholtz equation:

$$\frac{\partial }{\partial z} u ( ω , x , z ) = i \sqrt{\frac{{ω}^{2}}{{c}^{2} ( x , z )} + \frac{{\partial }^{2}}{\partial {x}^{2}}} u ( ω , x , z ) \qquad ( 1 WAY )$$

where ω denotes temporal frequency; x, z are the lateral and depth coordinates of the medium; c(x, z) is the heterogeneous (e.g., blocky) propagation velocity; and the PDO in the right-hand side of equation (1WAY):

$$\sqrt{\frac{{ω}^{2}}{{c}^{2} ( x , z )} - {k}_{x}^{2}}$$

is applied according to (PDO), with x=x₁, z=x₂. Here, equations (PDO) through (1WAY) provide examples of operators that encapsulate non-stationary corrupting functions that get convolved with the image, but which vary according to position within the image.

While the pseudo-differential operators (PDO) are versatile and useful for capturing various propagation phenomena, in particular embodiments computing a PDO can be resource-intensive, because equation (PDO) basically means that for each point of the transformed (e.g., corrupted) image a separate convolutional operator is applied to the entire image (an example of “non-stationary” convolution). Particular embodiments may therefore use one or more approximations to ameliorate the computational complexity. The following discussion uses vector notation x=(x₁, . . . , xₙ), ∂/∂x=(∂/∂x₁, . . . , ∂/∂xₙ) where n is the dimension of the image plane (typically n=2 as in FIGS. 4 and 5):

$$L ( \begin{matrix}2 & 1 \\ x , & \frac{\partial }{\partial x}\end{matrix} ) u ( x ) \approx {\sum }_{j = 1}^{K} {w}_{j} ( x ) [ L ( {\overline{x}}_{j} , \begin{matrix}1 \\ \frac{\partial }{\partial x}\end{matrix} ) u ( x ) ] \qquad ( INTERP )$$

where wⱼ(x) are interpolation coefficients and

$$L ( {\overline{x}}_{j} , \begin{matrix}1 \\ \frac{\partial }{\partial x}\end{matrix} )$$

are convolutional operators that correspond to fixed reference points x̅ⱼ, j=1, . . . , K (for example, points near the center and edges of an image). The interpolation weights we can be defined by, for example:

$${w}_{j} ( x ) = \frac{\vert x - {x}_{j} \vert}{{Σ}_{i = 1}^{K} \vert x - {x}_{i} \vert} , j = 1 , … , K \qquad ( INTERPW )$$

Application of (INTERP) involves K convolutions followed by a pointwise linear combination, resulting in a substantial reduction of computational complexity for conventional signals.

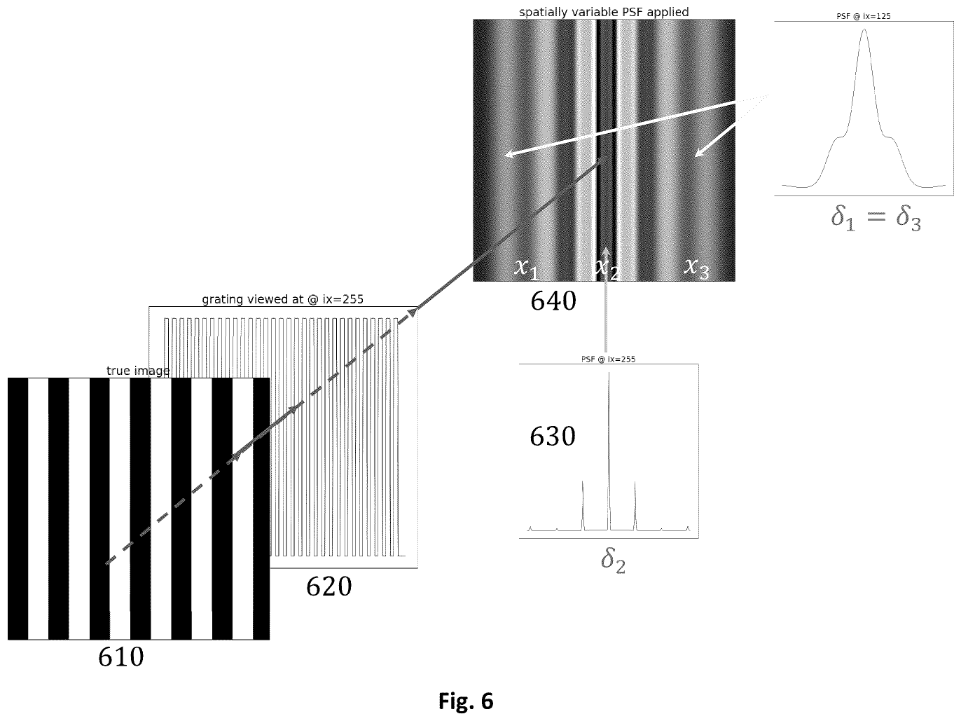

Equations (INTERP) through (BLUR_DIF) provide examples of non-stationary convolutional blurring operators, an example of which is illustrated in FIG. 6. FIG. 6 illustrates a synthetic example of a nonstationary convolution operator. In the example of FIG. 6, the spatial dependence of the convolutional operator is encoded in a single parameter—the smoothing of the central PSF:

$$L ( \begin{matrix}2 & 1 \\ x , & \frac{\partial }{\partial x}\end{matrix} ) = L ( \begin{matrix}2 & 1 \\ x , & \frac{\partial }{\partial x}\end{matrix} ) = {G}_{δ ( x )} ( x ) * {L}_{0} ( \frac{\partial }{\partial x} ) ≡ L ( f = δ , x , \frac{\partial }{\partial x} ) \qquad ( BLUR\_DIF )$$

$$where {L}_{0} ( \frac{\partial }{\partial x} )$$

is a convolutional operator that describes an angle-independent diffraction PSF, the blurring parameter δ(x) linearly changes from 30 μm at the edges to .5 μm at the center and is effectively the corruption operator parameter vector f=δ, and G_{δ(x)}(x) is a Gaussian kernel:

$${G}_{δ ( x )} ( x ) = {{δ}^{- 1} ( 2 π )}^{- \frac{1}{2}} exp \frac{- {x}^{2}}{2 {δ}^{2} ( x )} \qquad ( BLUR\_DIFF )$$

This example is effectively one-dimensional, allowing complete computational simulation even without employing interpolation (INTERP).

In the example of FIG. 6, image 610 illustrates a 512 μm wide true blue-light image that consists of 40 μm wide stripes and passes through a vertical grating 620 with 10 μm apertures and 8 μm opaque stripes. Additionally, angle-dependent blurring 630 is applied as represented by the broadening of the spatially variable PSF to produce the corrupted image 640. This particular example ignores angle-dependent phase effects, and therefore the operator (BLUR_DIF) is symmetric about the centerline, but those phase effects can be included as well.

To apply the example of FIG. 6 to the general multidimensional case, (INTERP) can be used with K=3 corresponding to coordinates x_{1,2,3}=125,255,384 μm (see FIG. 6) and the corresponding “corruption operator parameters” are δ₁=δ₃=15.25, δ₂=0.5.

FIG. 7 illustrates an example of an image 710 that is estimated using only a central PSF, an image 720 that is estimated using multi-PSF reconstruction, and an image 730 estimated using certain techniques disclosed herein. In this example (EST_F) is:

$$( {δ}_{1} = {δ}_{3} , {δ}_{2} ) = arg min {\sum }_{i = 1}^{K} {‖ L ( {δ}_{i} , x , \frac{\partial }{\partial x} ) {s}_{i} ( x ) - {g}_{i} ( x ) ‖}_{2}^{2} + α {‖ δ ‖}_{2}^{2} \qquad ( EST\_F2 )$$

where sᵢ(x) is a known point-source signal centered at xᵢ and gᵢ(x) is the corresponding measurement, and the regularization strength α∈[10⁻², 10²] has been selected using the discrepancy principle. Similarly, (OPT) becomes the following equation (OPT2):

$$( u ( x ) , {δ}_{1} = {δ}_{3} , {δ}_{2} ) = {‖ L ( δ , x , \frac{\partial }{\partial x} ) u ( x ) - d ( x ) ‖}_{2}^{2} + {σ}_{δ}^{- 2} ‖ δ - {δ}^{0} {‖}_{2}^{2} + λ {‖ ∇ u ( x ) ‖}_{2}^{2}$$

where u(x) is the unknown signal, strength λ∈[10⁻², 10 ²] has been selected using the discrepancy principle and the PDO is applied using (INTERP) and (INTERP_W). The estimate of the unknown image u(x) given by the solution to (OPT2) using the corruption parameters δ⁰=(δ₁=δ₃, δ₂) and scalar uncertainty (variance) estimate σ_{δ}² s produced by (EST_F2) from 3 PSF measurements is illustrated in image 720 of FIG. 7. Comparison with image 710, which uses Wiener deconvolution with the central PSF

$$L ( {δ}_{2} , x , \frac{\partial }{\partial x} ) ,$$

reveals a significantly improved signal recovery in image 720 near the edges.

Using only the central PSF, one can solve:

$$( u ( x ) , {δ}_{1} = {δ}_{3} , {δ}_{2} ) = arg min {‖ L ( δ , x , \frac{\partial }{\partial x} ) u ( x ) - d ( x ) ‖}_{2}^{2} + {σ}_{δ}^{- 2} ‖ δ - {δ}^{0} ‖ {‖}_{2}^{2} + λ {‖ ∇ u ( x ) ‖}_{2}^{2} + 100 {‖ M ( x ) u ( x ) ‖}_{2}^{2} \qquad ( OPT3 )$$

where M(x) is a masking function equal to 1 on a subset of the 0 amplitude true signal is expected (e.g., the bottom panel of FIG. 7). The last term in (OPT3) represents prior assumptions about the unknown signal, e.g., from domain knowledge. In (OPT3) δ⁰=(.5, .5, .5) but σ_{δ}=20, representing a high degree of uncertainty in the estimate of the corruption operator. The resulting estimate of the unknown signal is shown in the bottom row (i.e. image 730) of FIG. 7.

In this example both the PSF uncertainty estimate and signal prior information were crucial to signal recovery. By assuming uncertainty of the PSF parameters, a Wiener deconvolution could still be able to explain the observed signal for any values of the corruption parameters. Adding the mask-based informative prior in the last term of (OPT3) pushes the adjusted values of δ within their large uncertainty range toward more accurate corruption parameters δ₁=δ₃≈12 that can both explain the data and take into account the stringent prior. This example assumed a uniform homoscedastic noise, but the misfits can be generalized for more complex noise.

Alternative representations to the interpolation-based PDO approximations (INTERP) also exist is an important and useful approximation in practical applications. For example, the one-way Helmholtz operator of (1WAY) can approximated using a Padé approximation:

$$\sqrt{\frac{{ω}^{2}}{{c}^{2} ( x , z )} - {k}_{x}^{2}} = \frac{ω}{c ( x , z )} \sqrt{1 - {ξ}^{2}} \approx \frac{ω}{c ( x , z )} ( 1 - \frac{1}{2} {ξ}^{2} ) or \\ \sqrt{\frac{{ω}^{2}}{{c}^{2} ( x , z )} - {k}_{x}^{2}} \approx \frac{ω}{c ( x , z )} \frac{4 - 3 {ξ}^{2}}{4 - {ξ}^{2}} , ξ = \frac{{k}_{x} c ( x , z )}{ω}$$

Or more generally:

$$L ( \begin{matrix}2 & 1 \\ x , & \frac{\partial }{\partial x}\end{matrix} ) u ( x ) \approx \frac{P ( \begin{matrix}2 & 1 \\ x , & \frac{\partial }{\partial x}\end{matrix} )}{Q ( \begin{matrix}2 & 1 \\ x , & \frac{\partial }{\partial x}\end{matrix} )} u ( x ) , \qquad ( PADE )$$

where P( ) and Q( ) are multivariate polynomials with variable coefficients. Application of (OPT4) is equivalent to the application of a (partial) differential operator described by P( ) and subsequent solution of a (partial) differential equation described by Q( ). This may still represent computational savings when compared to the direct application of the nonstationary convolution operator (PDO). Particular embodiment of this disclosure may use PDOs that can be arbitrary linear combinations and cascaded application of both interpolated (INTERP) and Padé (PADE) representations, or, more generally, pseudo-differential operators with any order of applying differentiation and function multiplication, e.g.:

$$P ( \begin{matrix}p & q \\ x , & \frac{\partial }{\partial x}\end{matrix} ) u ( x ) = L ( \begin{matrix} & & & {q}_{1} & & {q}_{M} \\ {p}_{1} & & {p}_{L} & & & \\ & … & & & … & \\ x , & & x , & \frac{\partial }{\partial x} & & \frac{\partial }{\partial x}\end{matrix} ) u ( x )$$

In the following example, equations (OPT_PDO) through (REG0_PDO) mirror equations (OPT) through (REG0_F), above, providing specific estimates for the initial corrupting operator and its prior, but in the more specific case wherein image degradation can be described as the result of a pseudo-differential operator (such as a non-stationary PSF).

In this embodiment we consider corruption operators described by arbitrary pseudo-differential operators

$$L ( f , θ \begin{matrix}2 & 1 \\ x , & \frac{\partial }{\partial x}\end{matrix} )$$

that can be parameterized and represented in a variety of ways as discussed above. The following equation is labeled (OPT_PDO), and the first term on the right-hand side corresponds to −ln p(D|u, f), the second term corresponds to −ln p(u), and the third term corresponds to −ln q(f):

$$u , f = arg min {\sum }_{i = 1}^{N} {‖ w ( {θ}^{i} , x , u ( x ) ) \{ L ( f , {θ}^{i} \begin{matrix}p & q \\ x , & \frac{\partial }{\partial x}\end{matrix} ) u ( x ) - {d}^{i} ( x ) ‖}_{2}^{2} + {R}_{u} ( u ) + {R}_{f} ( f ) ,$$

where the unknown signal is now denoted as u(x) and is a function of spatial coordinates x=(x₁, . . . , xₙ), w is a weighting function that expresses assumptions about noise that could be both heterogeneous and heteroscedastic, θⁱ, i=1, . . . , N are signal (image) capture parameters (for example, exposures), R_{f} and Rᵤ are regularization or penalty terms for the parameter vector f and unknown signal u(x), respectively, and have the same interpretation as the corresponding terms in the discussion preceding the description of FIG. 2, with the difference that u(x) now represents the unknown signal. For example:

$$- ln q ( f ) = {R}_{f} ( f ) = \frac{1}{2} {( f - {f}_{0} )}^{*} {C}^{- 1} ( f ) ( f - {f}_{0} ) , \qquad ( REG\_FPDO )$$

where C(f) is a covariance matrix for parameter vector f, f₀ is the solution of:

$${f}_{0} = {\sum }_{i = 1}^{M} {‖ w ( {θ}^{i} , x , u ( x ) ) \{ L ( f , {θ}^{i} , \begin{matrix}p & q \\ x , & \frac{\partial }{\partial x}\end{matrix} ) {s}_{i} ( x ) - {g}^{i} ( x ) \} ‖}_{2}^{2} + {R}_{f}^{0} ( f ) , \qquad ( EST\_FPDO )$$

where θ₀ⁱ, i=1, . . . , M>>N are signal (image) capture parameters for an a-priori known signals sᵢ, R_{f}⁰(f) is a regularization term representing prior information about the corruption operator parameter vector f, for example:

$${R}_{f}^{0} ( f ) = \frac{1}{2} {( f - {f}_{A} )}^{*} {C}_{A}^{- 1} ( f ) ( f - {f}_{A} ) \qquad ( REG0\_FPDO )$$

where f_{A} and C_{A}(f) may come from an existing mathematical model of the corruption operator or from earlier measurements.

In the following example, equations (10)-(24) provide an approach for correcting an image that is corrupted by a stationary convolutional PSF and heteroscedastic noise, which is, e.g., typical of the actual photon shot noise observed in consumer camera sensors. In this embodiment the parameter vector f is assumed to represents a stationary PSF of the convolutional image formation model (1) and (4), and the misfit function in (OPT) is μ(x, y, z)=∥(x−y)/\sqrt{z}∥₂² and represents a heteroscedastic noise model suitable for photon shot noise:

ϵ_{d}^{τ}^{ᵢ}˜ [symbol] (0; σ²=σ_{d}²=τᵢf*x), (10)

ϵ_{g}^{τ}^{ᵢ}˜ [symbol] (0; σ²=σ_{g}²=τᵢh*f). (11)

The noise model (10) and (11) means that, ignoring saturated pixels where d^{τ}^{ᵢ}=c and g^{τ}^{ᵢ}=c, then:

$$- ln p ( {d}^{{τ}_{i}} \vert x , f ) = \frac{1}{2} {‖ {w}^{i} \frac{{τ}_{i} f * x - {d}^{{τ}_{i}}}{\sqrt{{τ}_{i} f * x}} ‖}^{2} , \qquad ( 12 )$$

$$- ln p ( {g}^{{τ}_{i}} \vert f ) = \frac{1}{2} {‖ {v}^{i} \frac{{τ}_{i} h * f - {g}^{{τ}_{i}}}{\sqrt{{τ}_{i} h * f}} ‖}^{2} , \qquad ( 13 )$$

where wⁱ, vⁱ are n×m matrices equal to 1 where 0<τⁱf*x<c and 0<τⁱh*f<c, respectively, and equal to zero otherwise. Empirically estimated unbiased variance of independent raw images with equal exposure demonstrates variance heterogeneity and supports the choice of the noise model (10) and (11).

To estimate the proposal distribution q(f) particular embodiments apply the following iterative procedure (iterative approximate inference):

$$q ( f ) = {lim}_{k \to ∞} {q}_{k} ( f ) , \qquad ( 14 )$$

$$ln {q}_{k} ( f ) = - \frac{1}{2} {\sum }_{i = 1}^{M} {‖ {v}^{i} \frac{{τ}_{i} h * f - {g}^{{τ}_{i}}}{{ξ}_{k - 1}^{i}} ‖}^{2} + ln p ( f ) , \qquad ( 15 )$$

$${ξ}_{0}^{i} = \sqrt{{g}^{{τ}_{i}}} + 1 - {v}^{i} , \qquad ( 16 )$$

$${ξ}_{k}^{i} = \sqrt{{τ}_{i} h * {f}_{k}} . \qquad ( 17 )$$

$${f}_{k} = arg max ln {q}_{k} ( f ) , k = 1 , 2 , … \qquad ( 18 )$$

where p(f) is the marginal distribution that represents prior information. For example, and without limitation:

p(f)∝δ(f−F[z])exp[−α∥∇z∥₁], (19)

where δ( ) is the discrete delta function, z is the binary aperture mask of the display, and F is the non-linear operator mapping the aperture mask into the PSF. The last term in (19) represents the “blockiness” prior (total variation regularization), and α is a prior hyperparameter. Once an approximate proposal distribution is obtained, q(f)≈qₖ(f), inference may be conducted:

$$x = {lim}_{k \to ∞} {x}_{k} , \qquad ( 20 )$$

$${x}_{k} , {f}_{k} = arg max - \frac{1}{2} {\sum }_{i = 1}^{N} {‖ {w}^{i} \frac{{τ}_{i} f * x - {d}^{{τ}_{i}}}{{η}_{k - 1}^{i}} ‖}^{2} + ln q ( f ) + ln p ( x ) , \qquad ( 21 )$$

$${η}_{0}^{i} = \sqrt{{d}^{{τ}_{i}}} + 1 - {w}^{i} ,$$

$${η}_{k}^{i} = \sqrt{{τ}_{i} {f}_{k} * {x}_{k}} , k = 1 , 2 , …$$

As before, p(x) is the marginal distribution that represents prior information. For example, and without limitation:

p(x)∝exp[−α∥Δx∥₂²] (24)

is a smoothness prior (second order Tikhonov regularization). The hyperparameter α controls the degree of smoothness and is selected using the estimated noise ε_{d} in (10) and the discrepancy principle. In this example, image reconstruction involves both HDR estimation and deconvolution.

As discussed herein, the potentially very complex and analytically intractable statistical relations between the observed (degraded) images G and the PSF f in equation (8) can be replaced with a tractable proposal distribution q(f) resulting in a more computationally tractable inference problem (9). In particular embodiments, the proposal distribution q(f) that approximates equation (8), instead of the procedure (14-18), can be described, without limitation, by a generative neural network trained on a dataset of synthetic or real low-dynamic range PSF measurements G, and applied in inference (9) for sampling from p (f|G)≈q(f) in combination with the inference process (20-23) or, without limitation, any other computational image inference (e.g., a neural-network image inference).

In particular embodiments, the proposal distribution p (D|x, f) in (9) can be described, without limitation, by a generative neural network trained on a dataset of synthetic or real low-dynamic range PSF measurements G and a dataset of synthetic or estimated PSFs f, synthetic or real undegraded images x, and applied in inference (9) for sampling from p(x|G, f) in combination with the inference process (14-18) or, without limitation, any computational PSF inference (e.g., a neural-network PSF inference and generator as described above).

In particular embodiments, the procedures of equations (14-18) and (20-24) and the generative neural network-based sampling methods of clauses discussed above may be replaced with any suitable generative singular statistical model.

Embodiments of this disclosure may be used in any suitable image-capturing application, including without limitation: photography and videography with mobile and devices, laptops, webcams, etc.; video-conferencing, video telephony, and telepresence; immersive gaming and educational applications, including those requiring gaze awareness and tracking; virtual and augmented reality applications, including those requiring gaze awareness and tracking; and visible and invisible band electromagnetic imaging such as used, without limitation, in medical and astronomical applications, non-destructive material testing, surveillance, and microscopy.

Embodiments of this invention may be utilized in any suitable device, including without limitation: any mobile device that includes one or more cameras (including one or more under-display cameras), such as cellular telephones, tablets, wearable devices, etc.; consumer electronics used in video-conferencing and video telephony, including built-in computer displays, vending/dispensing/banking machines, security displays, and surveillance equipment; consumer electronics used in gaming and augmented reality such as virtual and augmented reality headgear, optical and recreational corrective lenses, and simulation enclosures; and any imaging systems that include components that cause veiling or partial obstruction of optical apertures.

Particular embodiments disclosed herein improve images that have been blurred by nonlinear corruption operators, and such embodiments are therefore uniquely suited for de-blurring of images in the YUV (luma/chroma) color space. This is particularly relevant, for example, for existing image signal processor pipelines in mobile devices. In addition, because embodiments of this disclosure accurately recover a true PSF or corruption operator even if the initial PSF estimate was incorrect, such embodiments can recover blurred images even if the blurring operator has changed since it was initially characterized (e.g., during one-time setup prior to device deployment). The approaches described herein can thus be applied to cameras that have changed since manufacture or deployment.

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

What is claimed is:

1. A method comprising:
accessing (1) a corrupted image of a scene captured by a camera, (2) an estimated true image of the scene, (3) an estimated corruption operator f for the camera, and (4) one or more uncertainty metrics for f;
generating, by applying a corruption operation to the estimated true image and the corruption operator f, a predicted corrupted image of the scene captured by the camera;
determining a difference between the predicted corrupted image and the corrupted image captured by the camera;
determining, based on the one or more uncertainty metrics for f, a likelihood distribution for the corruption operator f; and
updating, based on the likelihood distribution for the corruption operator f and on the determined difference between the predicted corrupted image and the corrupted image captured by the camera, the estimated corruption operator f.

2. The method of claim 1, further comprising accessing one or more image priors for the corrupted image of the scene captured by the camera, wherein accessing an estimated true image of the scene comprises generating, based on the one or more image priors, the estimated true image.

3. The method of claim 2, further comprising updating, based on one or more image priors for the corrupted image of the scene and on the determined difference between the predicted corrupted image and the corrupted image captured by the camera, the estimated true image of the scene.

4. The method of claim 3, further comprising iteratively performing the method until at least one of:
the difference between the predicted corrupted image and the corrupted image captured by the camera is less than a difference threshold;
a change between two iterations in the difference between the predicted corrupted image and the corrupted image captured by the camera change is less than a convergence threshold; or
an iterative threshold is reached.

5. The method of claim 4, further comprising storing, after a final iteration, the updated estimated corruption operator f for use in correcting a subsequent corrupted image captured by the camera.

6. The method of claim 4, further comprising:
updating at least one of the one or more uncertainty metrics for f; and
storing, after a final iteration, the updated at least one of the one or more uncertainty metrics for f for use in correcting a subsequent corrupted image captured by the camera.

7. The method of claim 2, wherein accessing the one or more image priors for the corrupted image of the scene comprises:
determining, based on the accessed corrupted image of the scene capture by the camera, one or more characteristics of the scene; and
selecting, based on the determined one or more characteristics of the scene, at least one of the one or more image priors.

8. The method of claim 1, wherein the accessed estimated corruption operator f for the camera comprises an initial estimate of the corruption operator f generated by:
generating, by the camera, a corrupted image of a known input;
accessing one or more initial uncertainty metrics for the corruption operator f; and
determining, based on the one or more initial uncertainty metrics and on a difference between an estimated corrupted image of the known input and the generated corrupted image of the known input, the initial estimate of the corruption operator f.

9. The method of claim 8, wherein the accessed one or more uncertainty metrics for f comprise one or more initial uncertainty metrics for the corruption operator f as further updated based on the difference between the estimated corrupted image of the known input and the generated corrupted image of the known input.

10. The method of claim 1, further comprising
accessing one or more image-capture parameters θ; and
updating, based on (1) the determined difference between the predicted corrupted image, (2) the corrupted image captured by the camera, and (3) at least one of the one or more image-capture parameters θ, the estimated corruption operator f.

11. The method of claim 1, where the corruption operator f comprises at least one of:
a pseudo-differential operator;
a non-stationary point-spread function; or
a spatially invariant point-spread function.

12. The method of claim 11, wherein:
the corruption operator f comprises the spatially invariant point-spread function; and
the estimated true image of the scene is determined by Fourier-domain deconvolution of the corrupted image by the accessed corruption operator f.

13. The method of claim 1, wherein:
the corrupted image of the scene comprises one of a plurality of images of the scene, each of the plurality of images associated with a different exposure time; and
the corruption operator f comprises a high-dynamic-range corruption operator.

14. The method of claim 1, wherein:
the camera comprises a camera disposed behind a display structure of a device incorporating the camera; and
the corruption operator f is based on an obstruction created by the display structure.

15. One or more non-transitory computer readable storage media storing instructions and coupled to one or more processors that are operable to execute the instructions to:
access (1) a corrupted image of a scene captured by a camera, (2) an estimated true image of the scene, (3) an estimated corruption operator f for the camera, and (4) one or more uncertainty metrics fort,
generate, by applying a corruption operation to the estimated true image and the corruption operator f, a predicted corrupted image of the scene captured by the camera;
determine a difference between the predicted corrupted image and the corrupted image captured by the camera;
determine, based on the one or more uncertainty metrics for f, a likelihood distribution for the corruption operator f; and
update, based on the likelihood distribution for the corruption operator f and on the determined difference between the predicted corrupted image and the corrupted image captured by the camera, the estimated corruption operator f.

16. The media of claim 15, further comprising instructions coupled to one or more processors that are operable to execute the instructions to access one or more image priors for the corrupted image of the scene captured by the camera, wherein accessing an estimated true image of the scene comprises generating, based on the one or more image priors, the estimated true image.

17. A method comprising:
generating, by a camera, a corrupted image of a known input;
accessing one or more initial uncertainty metrics for a corruption operator f associated with the camera;
determining, based on the one or more initial uncertainty metrics and on a difference between an estimated corrupted image of the known input and the generated corrupted image of the known input, an initial estimate of the corruption operator f;
updating, based on the initial estimate of the corruption operator f, at least one of the one or more initial uncertainty metrics for the corruption operator f associated with the camera; and
storing, in association with the camera, the initial estimate of the corruption operator f and the one or more uncertainty metrics.

18. The method of claim 17, wherein the corrupted image of the known input comprises a plurality of corrupted images of the known input.

19. The method of claim 17, further comprising accessing one or more image-capture parameters θ, wherein the initial estimate of the corruption operator f is further determined based on the one or more image-capture parameters θ.

20. The method of claim 19, further comprising updating the at least one of the one or more initial uncertainty metrics based on the one or more image-capture parameters θ.
